(19) United States
(12) Patent Application Publication
(10) Pub. No.: US 2025/0190247 A1
(43) Pub. Date: Jun. 12, 2025

(54) PARALLEL EXECUTION OF COMMANDS AGAINST A VARIABLE NUMBER OF DATABASES

(71) Applicant: Oracle International Corporation, Redwood City, CA (US)

(72) Inventors: Ankur Nigam, Pleasanton, CA (US); Mark Anthony Lemoine, Livermore, CA (US); Narasimha Rao Gogineni, Frisco, TX (US)

(21) Appl. No.: 18/535,140

(22) Filed: Dec. 11, 2023

(51) Int. Cl. G06F 9/48

(52) U.S. Cl. CPC G06F 9/4881

(57) ABSTRACT

Embodiments of the present technology relate to systems and methods for running tasks in parallel against a variable number of databases stored on the same server. In an embodiment, a server hosting multiple databases receives a request to perform a job on the multiple databases. In response to the request, an agent on the server connects to each of the databases and stores pointers to the connection information in an array. The agent then passes the array to a service running Go that initializes multiple worker threads to complete the job on the multiple databases in parallel and passes each of the worker threads a reference to the array of pointers. In some examples, the job includes a health check and the workers, to complete the job, perform a health check on each of the multiple databases. The server then replies to the requesting entity with results of the job.

### TECHNICAL FIELD

Various embodiments of the present technology generally relate to parallel task processing. More specifically, embodiments of the present technology relate to systems and methods for running tasks in parallel against a variable number of databases stored on the same server.

### BACKGROUND

A server is a computer designed to manage network resources and provide services to other computers in the same network or over the internet. Unlike personal computers used for general purposes, servers are typically dedicated machines that handle specific tasks, such as managing databases, hosting websites, running applications, and more. Servers can be physical machines or virtualized machines, depending on a given deployment model (e.g., on-premises, cloud, or hybrid). Common types of servers include web servers, file servers, database servers, mail servers, application servers, and print servers.

Databases store and organize data in structured formats and are typically hosted on dedicated servers or within cloud environments. Database or storage servers play a crucial role in managing and organizing large volumes of data stored in databases. Databases hosted on servers are typically managed by specialized software known as Database Management Systems (DBMS). Various types of memory may be utilized by a server to optimize performance of the server and manage data stored in databases efficiently, including but not limited to random access memory, disk storage, caches, logs, and in-memory storage.

The Go programming language is often used on storage servers due to its design principles and features that align with the requirements of building efficient and scalable systems. Just a few examples of such principles and features that make Go a compelling choice for operating storage servers include Go's efficiency, its allowance for low-level control over system resources, its ease of use and readability, its concurrency features, and its scalability.

### OVERVIEW

Various embodiments of the present technology generally relate to parallel task processing. More specifically, embodiments of the present technology relate to systems and methods for running tasks in parallel against a variable number of databases stored on the same server. In an embodiment of the present technology, a method of operating a server that hosts multiple databases includes: by an agent on the server, receiving a request to perform a job with respect to the multiple databases on the server, establishing connections to the databases and generating pointers to connection information for the connections, and passing the pointers to a queue management service on the server that manages the job through a queue. The method further includes, by the queue management service, assigning the pointers through the queue to multiple workers threads on the server and, by the worker threads, in parallel, obtaining the connection information using the pointers, connecting to the databases using the connection information, and performing the job.

In some embodiments, the method further includes, by the agent, replying to the request with results of the job performed by the worker threads. In some examples, the job includes a health check with respect to the health of each of the databases and the results indicate a respective health of each one of the databases. The method may further include, by the agent, populating an array with the pointers and passing the array to the queue management service as an argument in a function call to the queue management service. In some examples, the job includes a set of tasks where each task corresponds to a different database of the multiple databases. The worker threads, to perform the job, progress through the array to perform a task of the set of tasks on each database of the multiple databases. In some examples, the agent instructs the queue management service regarding a number of worker threads to which to assign the pointers. Moreover, in some embodiments, the queue management service comprises Go code.

In an alternative embodiment, a server comprises one or more computer readable storage media, one or more processors operatively coupled with the one or more computer readable storage media, and program instructions stored on the one or more computer readable storage media. The program instructions include at least an agent and a queue management service. The program instructions, when executed by the one or more processors, direct the server to at least, by the agent, receive a request to perform a job with respect to multiple databases on the server, establish connections to the databases and generate pointers to connection information for the connections, and, after establishing the connections, pass the pointers to a queue management service on the server that manages the job through a queue. The program instructions further direct the server to, by the queue management service, assign the pointers through the queue to multiple worker threads on the server and, by the multiple worker threads in parallel, obtain, the connection information using the pointers, connect to the databases using the connection information, and perform the job.

In yet another embodiment, one or more non-transitory computer-readable storage media have program instructions stored thereon that include at least an agent and a queue management service. The program instructions, when read and executed by a processing system, direct the processing system to at least, by the agent, receive a request to perform a job with respect to multiple databases on a server, establish connections to the databases and generate pointers to connection information for the connections, and, after establishing the connections, pass the pointers to a queue management service on the server that manages the job through a queue. The program instructions further direct the processing system to, by the queue management service, assign the pointers through the queue to multiple worker threads on the server, and, by the multiple worker threads in parallel, obtain, the connection information using the pointers, connect to the databases using the connection information, and perform the job.

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIGS. 1A-1B illustrate an example of a storage server in which some embodiments of the present technology may be implemented;

FIG. 2 illustrates an example of a database environment in which some embodiments of the present technology may be implemented;

FIG. 3 illustrates an example of a parallel processing environment in accordance with some embodiments of the present technology;

FIG. 4 illustrates a series of steps for performing tasks on a plurality of databases in parallel in accordance with some embodiments of the present technology;

FIG. 5 illustrates and example operational scenario in accordance with some embodiments of the present technology; and

FIG. 6 illustrates a computing system for implementing parallel database task processing in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to parallel task processing in database environments. More specifically, the present technology includes systems and methods for parallel execution of commands against a variable number of databases using arrays in the Go programming language (i.e., “Go”).

The Go programming language is a frequently used language for programs related to networking and infrastructure. Go is often used for implementing fast processing tools in the networking and infrastructure industry because of the short processing times it provides. Go may be used, for example, in data storage environments including on servers that host a multitude of databases. In some implementations, Go is used to instruct server-executed functions including conducting health checks on the multitude of databases.

However, parallel execution of commands in Go against multiple databases on a single server requires declaring a pre-defined variable for each database connection due to databases having differing configurations. In the past, therefore, jobs to be performed on a plurality of databases hosted on a single server could not be executed in parallel because of the environment variable that must be set before initiating a connection. Moreover, when the list of databases on a server is dynamic and continually changing, defining database connection in set variables details can lead to errors. When a server hosting a multitude of databases and running Go was requested to execute a job on some or all of the multitude of databases, the connection details for each database were stored as independent variables before runtime, where each database has a different configuration (i.e., environment variable). The jobs therefore could not be executed in parallel despite the fact that Go supports parallel execution in general because the environment variable is overwritten each time a thread changes the variable to make a local database connection. This overwriting dilemma leads to jobs being executed multiple times on the same database instead of being executed a single time on each database. To circumvent this problem, jobs using the same environment variable are performed on each database on the server one at a time. In practice, this means that a worker thread makes a database connection and then must start and finish executing the command on the database before it, or another worker thread, initiates a new database connection. Parallel execution of jobs on multiple databases hosted on the same server is therefore not possible using existing technology and methods.

Therefore, the present technology enables execution of commands against any number of databases on a server in parallel without overwriting the database connection information using Go. To accompany such an improvement, the technology disclosed herein includes dynamic capture of the latest database configurations for establishing connectivity. The disclosed systems and methods may, in some embodiments, be implemented on ORACLE EXADATA servers in the ORACLE EXADATA database platform. However, it should be understood that the technology disclosed herein can be used for a multitude of purposes on any SAAS platform or by any database service that could benefit from parallel optimization. In addition to the benefit of parallel execution of commands against databases, the technology herein can be used for monitoring, patching, lifecycle management, corrective actions, configuration collection, and the like.

In accordance with the present disclosure, database connection information is stored in an array of pointers so that required commands can be executed in parallel against a multitude of databases using the latest database connection details. Thus, instead of storing connection details for various databases as independent variables, the memory location for each database connection is stored in the pointer array so that commands in Go can be executed in parallel against the pointer array. To avoid the problem of overriding database connections, actual connections are established with each of the databases with the connection details being stored in memory and the array is generated with pointers pointing to the connection information stored in memory for each database.

Thus, in an implementation of the technology, a server receives a command executable against a set of databases. In addition to indicating databases in the set, the command may, in some examples, include a priority level or a specific number of threads to assign to the job. In response to receiving the command, an agent of the server serially opens connections to each of the databases in the set. Then, instead of performing an operation on each database as the connection is established, the connection information for each individual database is stored in memory. Once the connections are established for the complete set of databases and the relevant connection information for each database is stored in memory, pointers to each database connection are stored in an array in memory. The pointer associated with each database contains the memory address of that database's connection information. A benefit of using pointers rather than storing a different variable type is that the pointer is not only used to store the memory address of the connection information, but it also points to where the memory is located and provides a way to find out the value stored at that memory location.

Once the array is created and the pointer values are stored, the agent or another main operating thread passes the array to the Go parallelism feature. To pass the array, the agent passes the array as an argument in a function call to the Go parallelism function. The Go parallelism function then initiates a number of worker threads based on the indicated priority level or the specified number of threads to use and passes each worker thread a reference to the array of pointers. Each worker thread performs the given command on the database that it is assigned, and the worker threads are able to perform the operations concurrently or in parallel. If the number of worker threads is less than the numbers of jobs to be performed (i.e., less than the number of databases in the set), then the worker threads increment, according to instructions from the Go parallelism function, through the array until each job has been assigned such that when one thread completes a job, it picks up the next job in the queue.

Various technical effects may be appreciated from the implementation disclosed herein, including increasing machine utilization without negatively impacting the quality of service. Additionally, technical effects that may be appreciated from the implementations herein include reduced processing times and a reduced number of errors. The technology described herein enables rapid execution of a command against any number of databases on a server using the latest database configuration, dramatically improving the speed of command execution. The technology further avoids having to store database connection details in multiple variables.

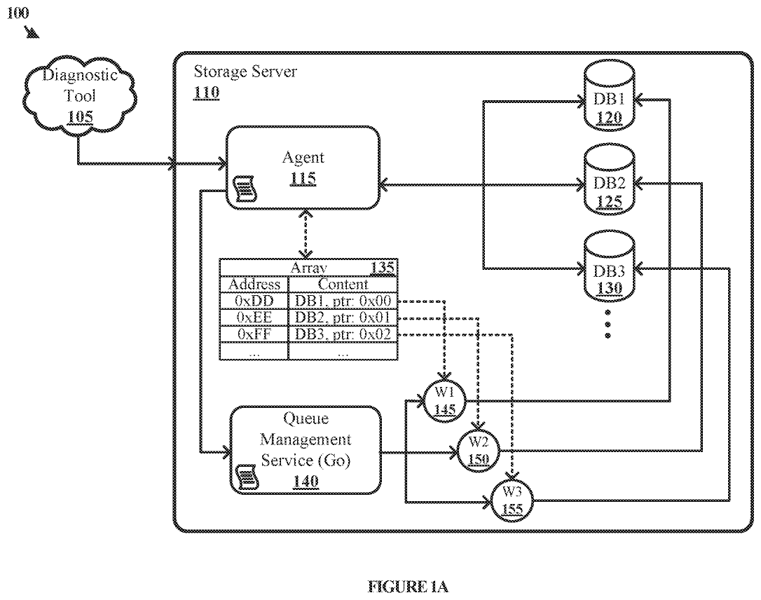

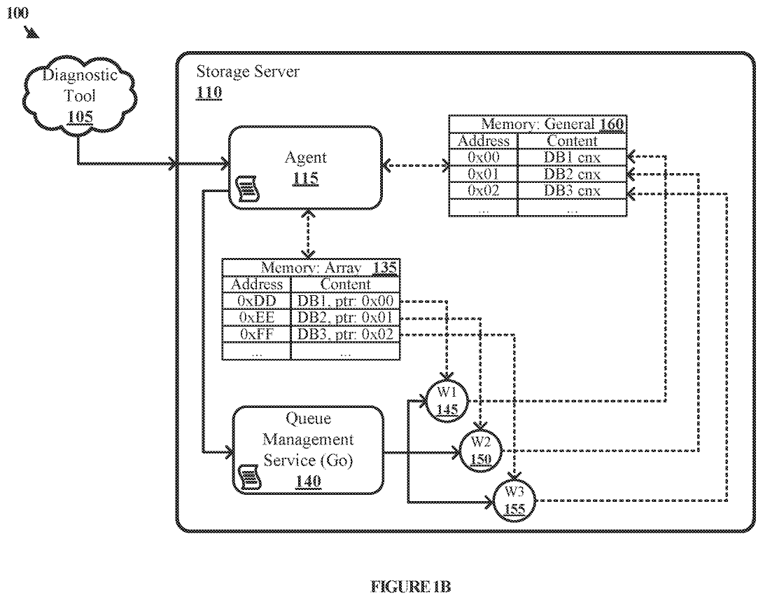

Referring now to the drawings, FIGS. 1A-1B illustrate database environment 100 in which some embodiments of the present technology may be implemented. FIG. 1A includes diagnostic tool 105 and storage server 110. Storage server 110 includes agent 115, database 120, database 125, database 130, array 135, queue management service 140, worker thread 145, worker thread 150, and worker thread 155. Diagnostic tool 105 is representative of any software service, micro-service, or the like that sends requests for diagnostic checks related to one or more databases on storage server 110. Diagnostic tool 105 is implemented on one or more computing devices. Examples of computing devices on which diagnostic tool 105 may run include personal computers, tablet computers, mobile phones, server computers, web servers, application servers, virtual or physical servers, or any combination or variation thereof, of which computing system 601 is broadly representative. In some examples, diagnostic tool 105 is running on an ORACLE EXADATA storage server in the ORACLE EXADATA database platform.

Storage server 110 is representative of any physical or virtual server computer or server network suitable for hosting a plurality of databases and processing incoming requests from diagnostic tool 105. Examples of storage server 110 include server computers, web servers, application servers, virtual or physical servers, or any combination thereof, of which computing system 601 is broadly representative. Storage server 110 and a computing device running diagnostic tool 105 may be implemented in the context of a cloud computing platform and/or co-located or distributed across one or more connected datacenters. Storage server 110, may host any number of databases which may include additional or fewer databases than what is shown in the example of FIGS. 1A-1B.

In accordance with FIG. 1A, diagnostic tool 105 sends a request to storage server 110 to perform a job with respect to multiple databases on storage server 110. The request, in some examples, includes an indication of priority or indicates a number of worker threads to utilize in completing the job. In some examples, diagnostic tool 105 is a health monitoring service and the job includes performing a health check on each database hosted on storage server 110, including database 120, database 125, and database 130. Agent 115 on storage server 110 receives the request. Agent 115 is representative of any code running on storage server 110 configured to receive requests from diagnostic tool 105, instantiate connections with databases on storage server 110, and pass jobs to queue management service 140. In some examples, agent 115 comprises code written in the Go programming language.

In response to receiving the request, agent 115 serially instantiates a connection with each database associated with the request. In some examples, every database hosted on storage server 110 is associated with the request, in which case agent 115 serially instantiates a connection with every database hosted on storage server 110. Instead of performing an operation on each database as the connection is established, however, agent 115 stores the connection information for each individual database at a unique address in memory. Once all of the connections are established and the relevant connection information for each database is stored in memory, agent 115 writes pointers to each database connection into array 135. In some examples, array 135 is a data structure in Go that stores homogenous elements and has a static size (i.e., the capacity of array 135 is defined at creation). Each pointer in array 135 holds the memory address for each database connection made by agent 115.

Once agent 115 has finished generating and populating array 135 with the connection information for each database, agent 115 passes the job to queue management service 140. In some implementations, to pass the job, agent 115 passes the array as an argument in a function call to queue management service 140. Additionally, in passing the job, agent 115 may, in some examples, also provide the indication of priority or indicate the number of worker threads to utilize in completing the job. In some examples, the number of worker threads to utilize is determined by queue management service 140 based on the indication of priority provided by agent 115 and/or diagnostic tool 105. Queue management service 140, in some examples, is representative of code that operates as a main thread suitable for initiating jobs on various worker threads of storage server 110. In the present example, queue management service 140 comprises code written in the Go programming language.

Queue management service 140, in response to receiving the job from agent 115, initiates a number of worker threads based on the indication of priority or an indication of the number of worker threads to utilize. In the present example, queue management service 140 initiates three worker threads to perform the job-worker thread 145, worker thread 150, and worker thread 155. To initiate the worker threads, queue management service 140 utilizes the Go parallelism function, which enables parallel execution of tasks across multiple threads. In addition to initiating worker thread 145, worker thread 150, and worker thread 155, queue management service 140, via the Go parallelism function, passes each worker thread a task including a reference to array 135 such that the worker threads increment through the pointers in array 135 until each task is completed. When a worker thread is passed a task, it first obtains a pointer to connection information for a database from array 135. The worker thread then uses the pointer to connect to the associated database. Once connected to the database, the worker thread performs the task before closing its connection and picking up the next task in the queue. The task, in some examples, includes performing a diagnostic health check on the database.

Thus, if there are more than three jobs to complete (i.e., more than three databases to perform the job on), each worker thread will take the next job from the queue when it finishes a job until all the jobs have been picked up. The Go parallelism function facilitates incrementation through array 135 as worker threads finish tasks. Once all the tasks are completed by worker thread 145, worker thread 150, and worker thread 155, the job results are reported back to diagnostic tool 105 by agent 115. The results, in some examples, indicate a respective health of each one of the databases.

In accordance with the present technology, the number of worker threads used can be scaled as high or as low as is available on the server. For example, for a very high priority job, every worker thread on storage server 110 may be utilized in parallel. Alternatively, for a low priority job, as few as two worker threads may be utilized in parallel.

FIG. 1B illustrates an alternative view of storage server 110. Storage server 110 includes the same components as shown in FIG. 1A, but further illustrates the database connections stored in memory. Thus, storage server 110 includes agent 115, database 120, database 125, database 130, array 135, queue management service 140, worker thread 145, worker thread 150, and worker thread 155, even though database 120, database 125, and database 130 are not shown in the current view of storage server 110.

Storage server 110, in FIG. 1B, is shown to include two types data stored in memory in accordance with the present technology-array 135 and memory 160. As previously described, agent 115 serially instantiates a connection to each database associated with the job request from diagnostic tool 105. The connection information for each database is then stored in memory 160. Once all of the database connections have been opened and the connection information for each database is stored in memory 160, agent 115 writes pointers to each database connection into array 135, which is then used by the worker threads to fetch the connection information from memory 160 as they increment through the tasks.

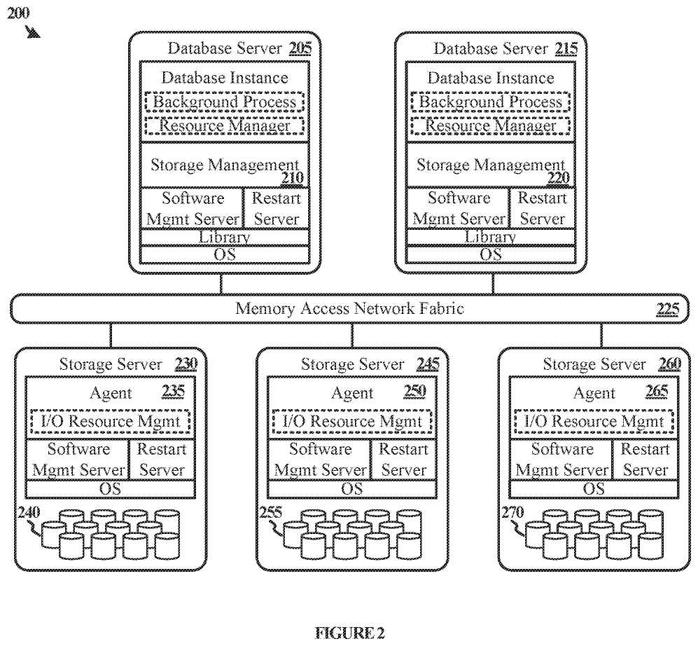

FIG. 2 illustrates database environment 200 in which some embodiments of the present technology may be implemented. Database environment 200 includes database server 205 and database server 215. Database server 205 includes storage management service 210 and database server 215 includes storage management service 220, either of which may be representative of diagnostic tool 105 from the preceding Figures. Database server 205 and database server 215 are representative of any physical or virtual server computers or server network suitable for hosting storage management service 210 and storage management service 220. Examples of database server 205 and database server 215 include server computers, web servers, application servers, virtual or physical servers, or any combination thereof, of which computing system 601 may be broadly representative.

Database environment 200 further includes storage server 230, storage server 245, and storage server 260. Storage server 230 includes agent 235 and databases 240. Storage server 245 includes agent 250 and databases 255. Storage server 260 includes agent 265 and databases 270. Any of storage server 230, storage server 245, and storage server 260 may be representative of storage server 110 from the preceding Figures. Storage server 230, storage server 245, and storage server 260 are representative of any physical or virtual server computers or server networks suitable for hosting a plurality of databases and processing incoming requests from database server 205 and/or database server 215. Examples of storage server 230, storage server 245, and storage server 260 include server computers, web servers, application servers, virtual or physical servers, or any combination thereof, of which computing system 601 may be broadly representative. Database server 205, database server 215, storage server 230, storage server 245, and storage server 260 may be implemented in the context of a cloud computing platform and/or co-located or distributed across one or more connected datacenters.

Any of agent 235, agent 250, and agent 265 may be, in some examples, representative of agent 115 from the preceding Figures. Similarly, any of databases 240, databases 255, and databases 270 may be, in some examples, representative of the databases hosted on storage server 110 from the preceding Figures, including but not limited to database 120, database 125, and database 130.

Database environment 200 further includes memory access network fabric 225, which is representative of an intelligent, high-speed, low-latency network fabric in some examples. Memory access network fabric 225, in some examples, is an internal ethernet fabric that connects all servers and storage in database environment 200, including but not limited to database server 205, database server 215, storage server 230, storage server 245, and storage server 260.

In an example, storage management service 210 hosted on database server 205 sends a request to storage server 230 to perform a health check on each database hosted on storage server 230 (i.e., databases 240). Agent 235 on storage server 230 receives the request, serially opens a connection with each database of databases 240, and stores the connection information for each connection in memory on storage server 230. Agent 235 also creates and populates an array containing pointers to the connection information for each database. Agent 235 then passes the array to a Go process on storage server 230 that initiates multiple worker threads to perform health checks on the databases in parallel. Once a health check on each database has been completed, agent 235 provides the results of the health checks back to storage management service 210 on database server 205.

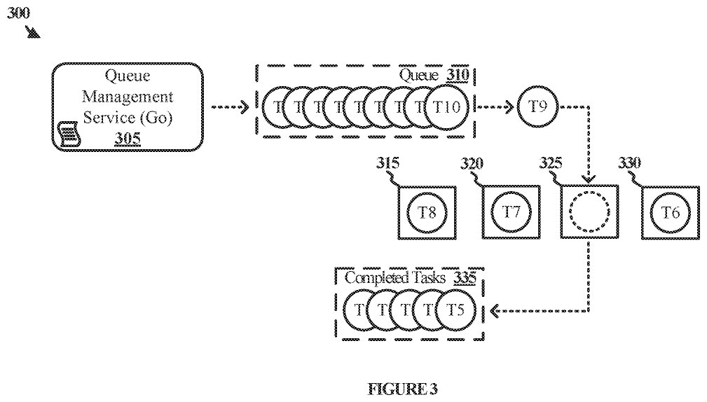

FIG. 3 illustrates parallel execution environment 300, an example of how tasks may be performed in parallel by a plurality of worker threads in accordance with some implementations of the present technology. Parallel execution environment 300 includes queue management service 305, queue 310, worker thread 315, worker thread 320, worker thread 325, worker thread 330, and completed tasks 335. Queue management service 305 is representative of Go code configured to initiate two or more worker threads to perform a task in parallel. Queue management service 305 may, in some implementations, utilize the parallel function provided in the Go programming language. Queue management service 305, in some examples, is representative of queue management service 140 on storage server 110 from the preceding Figures.

In accordance with the example of FIG. 3, queue management service 305 populates queue 310 with tasks to be performed. Each task in queue 310 may, in some examples, include a health check to be performed on an individual database, wherein the individual database is one of a plurality of databases hosted on the same server (e.g., storage server 110) as queue management service 305. More specifically, each task may include a reference to a variable stored in an array (e.g., array 135) such that the worker threads incrementally progress through the array until a health check is completed on each database (e.g., database 120, database 125, and database 130; databases 240). In the present example, eighteen total tasks have been assigned, wherein each task includes performing a health check on each individual database such that a health check is performed on all eighteen databases.

In the present example, four worker threads (i.e., worker thread 315, worker thread 320, worker thread 325, and worker thread 330) are assigned to perform the eighteen tasks. Thus, at any given time, up to four tasks are being performed simultaneously. When a task is completed, it is added to completed tasks 335 and the worker thread that completed the task picks up the next task from queue 310.

In the moment shown in FIG. 3, worker thread 315, worker thread 320, worker thread 325, and worker thread 330 are progressing through the eighteen tasks queued by queue management service 305. Tasks one through five have been completed and are thus shown in completed tasks 335. Task six is being executed by worker thread 320. Task seven is being executed by worker thread 320. Task eight is being executed by worker thread 315. Worker thread 325 has recently completed a task and is therefore going to pick up task nine from queue 310. Tasks eleven through eighteen are yet to be picked up by a worker.

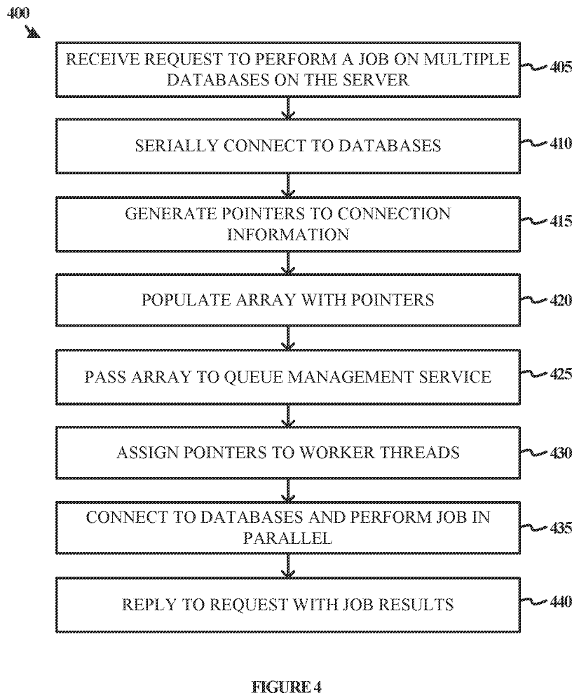

FIG. 4 illustrates process 400 for implementing parallel execution of tasks on locally stored databases as described herein. Process 400 may be implemented in program instructions in the context of any software applications, modules, components, or other such elements of a server. For example, process 400 may be employed by one or more modules of code on storage server 110, or by another server running in the context of database environment 200. The program instructions direct the server to operate as follows.

In step 405 of process 400, the server (e.g., storage server 110) receives a request to perform a job on multiple databases on the server. The request to perform a job, in some examples, is a request to perform a health check on each database hosted on the server. Receiving the request is, in some examples, performed by an agent on the server (e.g., agent 115). The agent may in some examples be representative of a Go code module. In step 410 of process 400, the agent serially connects to each database of the multiple databases (e.g., database 120, database 125, database 130) on the server and stores the connection information for each database in memory (e.g., memory 160). Once the agent has connected to each database and stored the connection information in memory, it populates an array (e.g., array 135) with pointers to the connection information in memory in step 420. Each pointer in the array points to the location of one database connection in memory.

Once the array is created and populated with the pointers, the agent passes it to a queue management service (e.g., queue management service 140) on the same server in step 425. The queue management service, in some examples, is representative of a Go code module suitable for instructing worker threads on the server to perform tasks in parallel. The queue management operates as a main thread instructing the plurality of worker threads. Passing the array to the queue management service, in some examples, includes passing the array as an argument in a function call to the queue management service.

In step 430, the queue management service assigns some or all of the pointers in the array to worker threads on the server. For example, if the queue management service assigns four worker threads to perform ten total tasks, one task will be assigned to each worker thread and four tasks will not be immediately assigned. Instead, the worker threads will incrementally progress through the tasks by incrementally progressing through the array as they complete earlier tasks until all tasks are completed or in progress. In step 435, the worker threads connect to the databases using the pointers in the array. When a worker thread accesses a pointer in the array, it uses the pointer to fetch the database connection information from memory. The worker thread then uses the database connection information stored in memory to perform a task on the associated database. Once the job has been performed on all the databases, the server replies to the request with the job results.

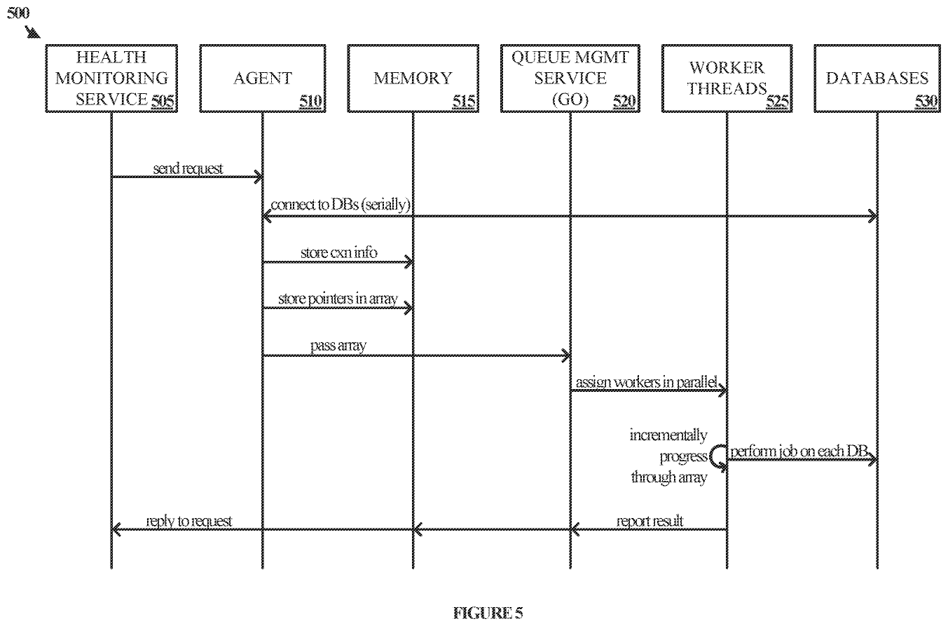

FIG. 5 illustrates operational scenario 500 in which the parallel execution of database related tasks in accordance with the present disclosure is implemented. Operational scenario 500 includes health monitoring service 505, agent 510, memory 515, queue management service 520, worker threads 525, and databases 530. Health monitoring service 505 is representative of any program or module capable of requesting health checks for databases 530 (e.g., diagnostic tool 105, storage management service 210). In some implementations, health monitoring service 505 runs on a server separate from the server that hosts agent 510, memory 515, queue management service 520, worker threads 525, and databases 530. In alternative implementations, health monitoring service 505 runs on the same server that hosts agent 510, memory 515, queue management service 520, worker threads 525, and databases 530. In other implementations, health monitoring service 505 runs on a personal computing device such as a desktop computer, laptop computer, or a mobile phone.

Agent 510 is representative of code running on the same server as databases 530 (e.g., agent 115, agent 235) capable of receiving a request from health monitoring service 505 and implementing the tasks described herein in reference to agent 510. In some examples, agent 510 comprises Go code. Memory 515 is representative of any form or combinations of forms of memory available on the server hosting agent 510 and databases 530 including but not limited to random access memory, flash memory, caches, and the like (e.g., memory 160). Queue management service 520 is representative of code running on the same server as agent 510 and databases 530 (e.g., queue management service 140, queue management service 305) capable of initiating worker threads 525 to progress through an array containing pointers to database connections stored in memory by agent 510. In some examples, queue management service 520 comprises Go code.

Worker threads 525 are representative of two or more worker threads that may be spun up by queue management service 520 to perform tasks on databases 530 in parallel (e.g., worker thread 145, worker thread 150, worker thread 155, worker thread 315, worker thread 320, worker thread 325, worker thread 330). Databases 530 are representative of two or more databases hosted on the same server as at least agent 510, memory 515, queue management service 520, and worker threads 525 (e.g., databases 120-130, databases 240, databases 255, databases 270). Databases 530 may utilize various types of memory including but not limited to random access memory, disk storage, caches, logs, in-memory databases, and the like.

In accordance with the present example, health monitoring service 505 sends a request to perform a database health check on a server hosting agent 510. The request is received by agent 510. In response to receiving the request, agent 510 connects to each database of databases 530 in serial. In some examples, the request is for all databases on the server, in which case databases 530 represents all databases on the server. In other examples, the request is for a specified subset of databases on the server, in which case databases 530 represents the subset. When agent 510 opens a connection to each database of databases 530, it stores the connection information for each database in memory 515. Once all of the connections to databases 530 have been opened and are stored in memory 515, agent 510 stores pointers to the connection information in an array and stores the array in memory 515. Once the array is created and populated with the pointers, agent 510 passes the array to queue management service 520.

Queue management service 520, in response to agent 510 passing the array, assigns worker threads 525 to perform the health checks on databases 530 in parallel and passes the array to the worker threads. As previously described, queue management service 520 may assign a number of worker threads based on a priority level indicated in the initial request or based on a priority level indicated to queue management service 520 by agent 510. In other examples, queue management service 520 may assign a number of worker threads based on a number of threads indicated in the original request or a number of threads indicated by agent 510. In other examples, queue management service 520 does not receive an indication of priority or a number of worker threads and selects the number of worker threads to utilize itself and/or utilizes the maximum number of worker threads available.

Once each worker thread of worker threads 525 is spun up, the worker threads perform the health check on each database in databases 530, incrementally progressing through the array until all tasks have been picked up or completed. Once every health check is complete, the results are passed back to health monitoring service 505. In some examples, to reply to the request, the worker threads report the results of each health check to queue management service 520, which reports the results to agent 510, which reports the results back to health monitoring service 505.

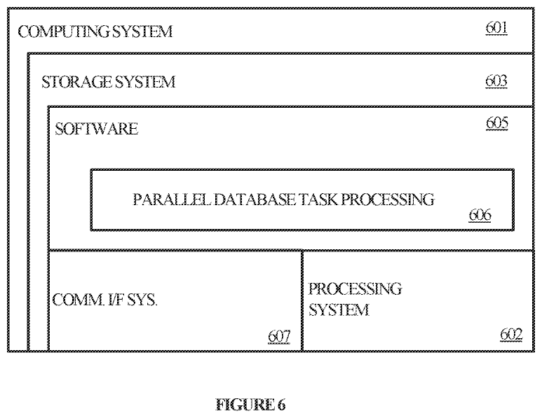

FIG. 6 illustrates computing system 601 that is representative of any system or collection of systems in which the various processes, systems, programs, services, and scenarios disclosed herein may be implemented. For example, computing system 601 may be broadly representative of any or all of storage server 110, database server 205, database server 215, storage server 230, storage server 245, and storage server 260. Examples of computing system 601 include, but are not limited to, server computers, web servers, cloud computing platforms, data center equipment, desktop computers, laptop computers, and routers, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607. Computing system 601 may, in some embodiments, further include a user interface system. Processing system 602 is operatively coupled with storage system 603, and communication interface system 607.

Processing system 602 loads and executes software 605 from storage system 603. Software 605 includes and implements parallel database task processing 606, which may be representative of any of the processes discussed with respect to the preceding Figures. When executed by processing system 602 to provide a parallel database task processing, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including parallel database task processing 606) may be implemented in program instructions and among other functions may, when executed by processing system 602, direct processing system 602 to operate as described with respect to the various operational scenarios, sequences, and processes illustrated herein. For example, software 605 may include program instructions for implementing a parallel tasks on a database server as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to perform parallel database task processing as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of cloud storage and/or datacenters, it should be understood the parallel task processing systems and methods described herein are not limited to such embodiments and may apply to a variety of other database environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. A method of operating a server that hosts multiple databases, the method comprising:
by an agent on the server:
receiving a request to perform a job with respect to the multiple databases on the server;
establishing connections to the databases and generating pointers to connection information for the connections; and
after establishing the connections, passing the pointers to a queue management service on the server that manages the job through a queue;
by the queue management service, assigning the pointers through the queue to multiple worker threads on the server; and
by the worker threads, in parallel:
obtaining the connection information using the pointers;
connecting to the databases using the connection information; and
performing the job.

2. The method of claim 1, wherein the job comprises a health check with respect to health of each of the databases, and wherein the method further comprises, by the agent, replying to the request with results of the job performed by the worker threads, wherein the results indicate a respective health of each one of the databases.

3. The method of claim 1, further comprising, by the agent, populating an array with the pointers, wherein passing the pointers to the queue management service comprises passing the array as an argument in a function call to the queue management service.

4. The method of claim 3, wherein the job comprises a set of tasks and each task of the set of tasks corresponds to a different database of the multiple databases.

5. The method of claim 4, wherein performing the job comprises, by the worker threads, incrementally progressing through the array to perform a task of the set of tasks on each database of the multiple databases.

6. The method of claim 1, further comprising, by the agent, instructing the queue management service regarding a number of worker threads to which to assign the pointers.

7. The method of claim 1, wherein the queue management service comprises Go code.

8. A server comprising:
one or more computer readable storage media;
one or more processors operatively coupled with the one or more computer readable storage media; and
program instructions comprising at least an agent and a queue management service, wherein the program instructions are stored on the one or more computer readable storage media and, when executed by the one or more processors, direct the server to at least:
by the agent:
receive a request to perform a job with respect to multiple databases on the server;
establish connections to the databases and generate pointers to connection information for the connections;
after establishing the connections, pass the pointers to a queue management service on the server that manages the job through a queue;
by the queue management service, assign the pointers through the queue to multiple worker threads on the server; and
by the multiple worker threads, in parallel:
obtain, the connection information using the pointers;
connect to the databases using the connection information; and
perform the job.

9. The server of claim 8, wherein the job comprises a health check with respect to health of each of the databases, and wherein the program instructions further direct the server to, by the agent, reply to the request with results of the job performed by the worker threads, wherein the results indicate a respective health of each one of the databases.

10. The server of claim 8, wherein the program instructions further direct the server to, by the agent, populate an array with the pointers, wherein to pass the pointers to the queue management service, the agent passes the array as an argument in a function call to the queue management service.

11. The server of claim 10, wherein the job comprises a set of tasks and each task of the set of tasks corresponds to a different database of the multiple databases.

12. The server of claim 11, wherein to perform the job, the program instructions direct the server to, by the worker threads, incrementally progress through the array to perform a task of the set of tasks on each database of the multiple databases.

13. The server of claim 8, wherein the program instructions further direct the server to, by the agent, instruct the queue management service regarding a number of worker threads to which to assign the pointers.

14. The server of claim 8, wherein the queue management service comprises Go code.

15. One or more non-transitory computer-readable storage media having program instructions stored thereon comprising at least an agent and a queue management service, wherein the program instructions, when read and executed by a processing system, direct the processing system to at least:
by the agent:
receive a request to perform a job with respect to multiple databases on a server;
establish connections to the databases and generate pointers to connection information for the connections;
after establishing the connections, pass the pointers to a queue management service on the server that manages the job through a queue;
by the queue management service, assign the pointers through the queue to multiple worker threads on the server; and
by the multiple worker threads, in parallel:
obtain, the connection information using the pointers;
connect to the databases using the connection information; and
perform the job.

16. The one or more non-transitory computer-readable storage media of claim 15, wherein the job comprises a health check with respect to health of each of the databases, and wherein the program instructions further direct the processing system to, by the agent, reply to the request with results of the job performed by the worker threads, wherein the results indicate a respective health of each one of the databases.

17. The one or more non-transitory computer-readable storage media of claim 15, wherein the program instructions further direct the processing system to, by the agent, populate an array with the pointers, wherein to pass the pointers to the queue management service, the agent passes the array as an argument in a function call to the queue management service.

18. The one or more non-transitory computer-readable storage media of claim 17, wherein the job comprises a set of tasks and each task of the set of tasks corresponds to a different database of the multiple databases.

19. The one or more non-transitory computer-readable storage media of claim 18, wherein to perform the job, the program instructions direct the processing system to, by the worker threads, incrementally progress through the array to perform a task of the set of tasks on each database of the multiple databases.

20. The one or more non-transitory computer-readable storage media of claim 15, wherein the program instructions further direct the processing system to, by the agent, instruct the queue management service regarding a number of worker threads to which to assign the pointers.
